(19) United States
(12) Patent Application Publication
(10) Pub. No.: US 2024/0314819 A1
(43) Pub. Date: Sep. 19, 2024

(54) METHOD, DEVICE AND COMPUTER STORAGE MEDIUM OF COMMUNICATION

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 18/577,058

(22) PCT Filed: Jul. 8, 2021
(86) PCT No.: PCT/CN2021/105337

§ 371 Date: Jan. 5, 2024

(51) Int. Cl. H04W 72/40; H04L 1/1812; H04W 72/0446; H04W 72/25; H04W 72/566

(52) U.S. Cl. CPC H04W 72/40; H04L 1/1812; H04W 72/0446; H04W 72/25; H04W 72/566

(57) ABSTRACT

Embodiments of the present disclosure relate to methods, devices and computer readable media for communication. A first device determines a resource from a resource set configured for transmission of coordination information, the coordination information indicating the presence or absence of a collision on a set of resources to be used by a second device, a first slot for the determined resource being earlier than a second slot for the set of resources by a number of slots, the number of slots being less than a threshold number. Then the first device transmits the coordination information to the second device on the determined resource. Upon reception of the coordination information, the second device determines whether the set of resources are available. In this way, the coordination information may be transmitted in proper resources, and thus inter-UE coordination may be enhanced and resource utilization may be improved.

### TECHNICAL FIELD

Embodiments of the present disclosure generally relate to the field of telecommunication, and in particular, to methods, devices and computer storage media of communication for sidelink transmission.

### BACKGROUND

For inter-user equipment (inter-UE) coordination in resource allocation Mode 2 of sidelink transmission, it is agreed to support inter-UE coordination schemes 1 and 2. In the inter-UE coordination scheme 1, coordination information (CI) sent from UE-A to UE-B is the set of resources preferred and/or non-preferred for UE-B's transmission. In the inter-UE coordination scheme 2, CI sent from UE-A to UE-B is the presence of expected or potential and/or detected resource conflict on the resources indicated by UE-B's sidelink control information (SCI).

However, for the inter-UE coordination scheme 2, a container or signaling format of the CI (i.e., a container or signaling format of the presence of expected or potential and/or detected resource conflict on the resources indicated by UE-B's SCI) is undetermined.

### SUMMARY

In general, embodiments of the present disclosure provide methods, devices and computer storage media of communication for sidelink transmission.

In a first aspect, there is provided a method of communication. The method comprises: determining, at a first device, a resource from a resource set configured for transmission of coordination information, the coordination information indicating the presence or absence of a collision on a set of resources to be used by a second device, a first slot for the determined resource being earlier than a second slot for the set of resources by a number of slots, the number of slots being less than a threshold number; and transmitting the coordination information to the second device on the determined resource.

In a second aspect, there is provided a method of communication. The method comprises: receiving, at a second device, coordination information from a set of first devices on a determined resource associated with a set of resources to be used by the second device, the coordination information indicating the presence or absence of a collision on the set of resources, a first slot for the determined resource being earlier than a second slot for the set of resources by a number of slots, the number of slots being less than a threshold number; and determining, based on the coordination information, whether the set of resources are available.

In a third aspect, there is provided a terminal device. The terminal device comprises a processor configured to perform the method according to the first or second aspect of the present disclosure.

In a fourth aspect, there is provided a computer readable medium having instructions stored thereon. The instructions, when executed on at least one processor, cause the at least one processor to perform the method according to the first or second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2A illustrates a schematic diagram illustrating an example scenario of inter-UE coordination according to embodiments of the present disclosure;

FIG. 2B illustrates a schematic diagram illustrating another example scenario of inter-UE coordination according to embodiments of the present disclosure;

FIG. 3 illustrates a schematic diagram illustrating a process for communication in CI transmission according to embodiments of the present disclosure;

FIG. 4 illustrates a schematic diagram illustrating an example process for configuring a resource set for CI transmission according to embodiments of the present disclosure;

FIG. 5A illustrates a schematic diagram illustrating an example process for determining at least one available resource from the resource set according to embodiments of the present disclosure;

FIG. 5B illustrates a schematic diagram illustrating another example process for determining at least one available resource from the resource set according to embodiments of the present disclosure;

FIG. 6 illustrates a schematic diagram illustrating an example process for determining a resource from the at least one available resource for CI transmission according to embodiments of the present disclosure;

FIG. 7A illustrates a schematic diagram illustrating another example process for determining a resource for CI transmission according to embodiments of the present disclosure;

FIG. 7B illustrates a schematic diagram illustrating still another example process for determining a resource for CI transmission according to embodiments of the present disclosure;

FIG. 8 illustrates a flowchart illustrating an example method of communication implemented at a first device serving as a transmitter of CI in accordance with some embodiments of the present disclosure;

FIG. 9 illustrates a flowchart illustrating an example method of communication implemented at a second device serving as a receiver of CI in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, UE, personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term “includes” and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as “at least one other embodiment.” The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, the container or signaling format of CI for the inter-UE coordination scheme 2 is undetermined. In the context of the present application, the CI in question refers to the presence of expected or potential and/or detected resource conflict on the resources indicated by UE-B's SCI.

Embodiments of the present disclosure provide a solution for solving the above and other potential issues. In the solution, a first device determines a resource from a resource set configured for CI transmission and transmits the CI to a second device on the determined resource. The CI indicates the presence or absence of a collision on a set of resources to be used by the second device. A first slot for the determined resource is earlier than a second slot for the set of resources by a number of slots, and the number of slots is less than a threshold number. In this way, resource conflicts on the set of resources to be used by the second device may be fully detected and reported on a proper resource.

Principles and implementations of the present disclosure will be described in detail below with reference to the figures.

### Example of Communication Network

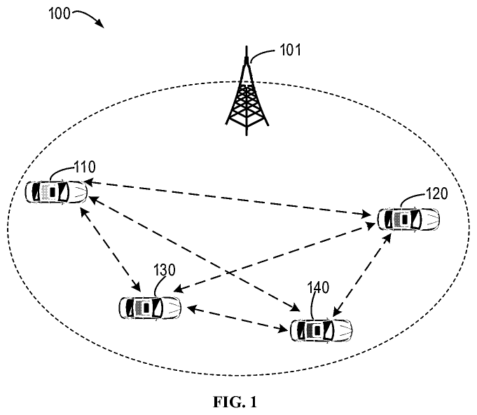

FIG. 1 illustrates a schematic diagram of an example communication network 100 in which some embodiments of the present disclosure can be implemented. As shown in FIG. 1, the communication network 100 may include a first device 110, a second device 120, a third device 130, a fourth device 140 and a fifth device 101 that can communicate with each other. In this example, the first device 110, the second device 120, third device 130 and the fourth device 140 are illustrated as terminal devices (vehicles), and the fifth device 101 is illustrated as a network device serving the terminal devices. Thus, the serving area of the fifth device 101 is called as a cell as shown in dash line.

It is to be understood that the number of devices in FIG. 1 is given for the purpose of illustration without suggesting any limitations to the present disclosure. The communication network 100 may include any suitable number of network devices and/or terminal devices and/or cells adapted for implementing implementations of the present disclosure.

Further, the first, second, third and fourth devices 110, 120, 130 and 140 are shown in FIG. 1 as vehicles which enable sidelink communications. It is to be understood that embodiments of the present disclosure are also applicable to other devices than vehicles, such as mobile phones, sensors and so on. The first, second, third and fourth devices 110, 120, 130 and 140 may communicate with each other via a sidelink channel. The sidelink channel may be a sidelink control channel such as a physical sidelink control channel (PSCCH), or a sidelink data channel such as a physical sidelink shared channel (PSSCH). The sidelink control channel may further comprise a sidelink feedback channel such as a physical sidelink feedback channel (PSFCH). Each of the first, second, third and fourth devices 110, 120, 130 and 140 may broadcast SCI over the sidelink control channel such as PSCCH. Each of the first, second, third and fourth devices 110, 120, 130 and 140 may transmit an acknowledgement for sidelink data reception (such as PSSCH reception) over the sidelink feedback channel such as PSFCH.

Although not shown, the fifth device 101 may communicate with the first, second, third and fourth devices 110, 120, 130 and 140 via channels (such as, wireless communication channels), respectively. In the case where the first, second, third and fourth devices 110, 120, 130 and 140 are the terminal devices and the fifth device 101 is the network device, the channels may be a physical uplink control channel (PUCCH) or physical uplink share channel (PUSCH) in a link from the first, second, third and fourth devices 110, 120, 130 and 140 to the fifth device 101 or a physical downlink control channel (PDCCH) or physical downlink share channel (PDSCH) in a link from the fifth device 101 to the first, second, third and fourth devices 110, 120, 130 and 140.

It is to be noted that although the first, second, third and fourth devices 110, 120, 130 and 140 are shown in the cell provided by the fifth device 101, the first, second, third and fourth devices 110, 120, 130 and 140 may directly communicate with each other without intervene of the fifth device 101. Of course, the first, second, third and fourth devices 110, 120, 130 and 140 may communicate with each other fully or partially via the fifth device 101.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

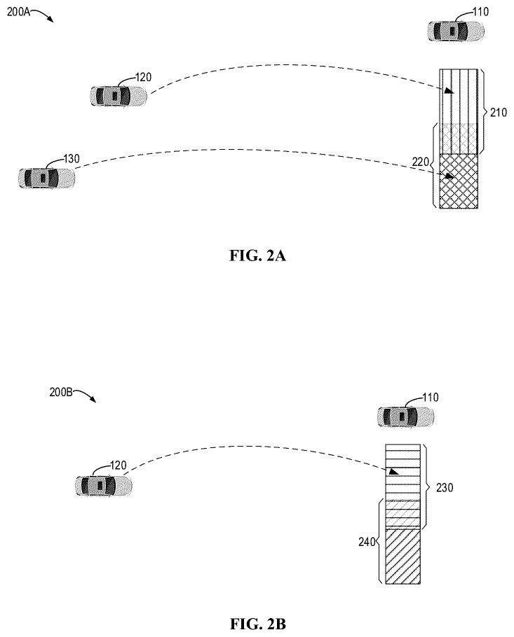

In some scenarios, the second device 120 may indicate in SCI that a set of resources is reserved or to be used by the second device 120. The second device 120 does not know whether there is any collision on the set of resources, but another device (for example, the first device 110) may know whether there is a collision on the set of resources. The details will be described below in connection with FIGS. 2A and 2B.

FIG. 2A illustrates a schematic diagram illustrating an example scenario 200A of inter-UE coordination according to embodiments of the present disclosure. For the purpose of discussion, the scenario 200A will be described with reference to FIG. 1. As shown in FIG. 2A, the second device 120's SCI indicates a set of resources 210 to be used, and the third device 130's SCI indicates another set of resources 220 to be used. The set of resources 210 are partly overlapped with the other set of resources 220. A device other than the second device 120 and the third device 130 (for example, the first device 110) may know from the second device 120's SCI and the third device 130's SCI that there is a collision on the set of resources 210 and the other set of resources 220. However, neither the second device 120 nor the third device 130 knows the collision.

In this case, the first device 110 may transmit CI to the second device 120 to inform the collision on the set of resources 210, and may also transmit another CI to the third device 130 so as to inform of the collision on the other set of resources 220. In this scenario 200A, the first device 110 may be any devices other than the second and third devices 120 and 130, including a receiver device.

FIG. 2B illustrates a schematic diagram illustrating another example scenario 200B of inter-UE coordination according to embodiments of the present disclosure. For the purpose of discussion, the scenario 200B will be described with reference to FIG. 1. As shown in FIG. 2B, the second device 120's SCI indicates a set of resources 230 to be used. The first device 110 may receive the second device 120's SCI and know that the set of resources 230 is to be used by the second device 120. However, the first device 110 is intended to perform a transmission on another set of resources 240 which is partly overlapped with the set of resources 230. In other words, the first device 110 knows there is a collision on the set of resources 230. In this case, the first device 110 may transmit CI to the second device 120 so as to inform of the collision on the set of resources 210. In this scenario 200B, the first device 110 may be only a receiver device.

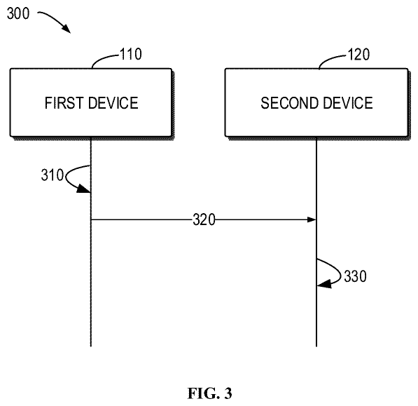

In either case, a channel or signaling for the CI transmission needs to be designed. Embodiments of the present disclosure provide a channel or signaling like a sidelink feedback channel such as PSFCH for the CI transmission. More details will be described below in connection with FIGS. 3 to 7B.

### Example Implementation of CI Transmission

FIG. 3 illustrates a schematic diagram illustrating a process 300 for communication in CI transmission according to embodiments of the present disclosure. For the purpose of discussion, the process 300 will be described with reference to FIG. 1. The process 300 may involve the first device 110 and the second device 120 as illustrated in FIG. 1. Assuming that the first device 110 knows a collision on a set of resources to be used by the second device 120 and is intended to transmit CI to inform the second device 120 of the collision.

As shown in FIG. 3, the first device 110 determines 310 a resource from a resource set configured for CI transmission. The CI indicates the presence or absence of the collision. The first device 110 may determine the resource so that a first slot for the determined resource is earlier than a second slot for the set of resources by a number of slots and the number of slots is less than a threshold number. In this way, resource collisions may be fully covered or detected.

It is to be understood that the number of slots may be determined in a timing unit of a slot, sub-slot, symbol, or mini-slot. Of course, any other suitable timing units are also feasible.

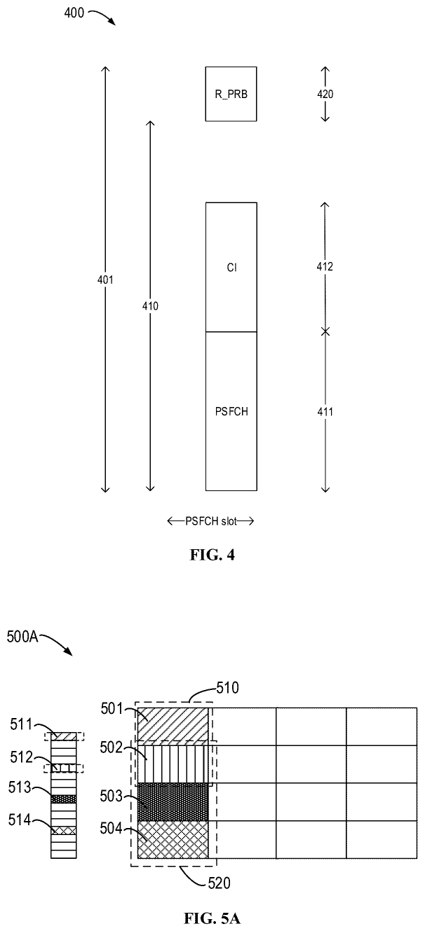

In some embodiments, the resource set configured for CI transmission may be configured in the same slot as that for PSFCH transmission, i.e., in PSFCH slots. Some examples of the configuration of the resource set will be described in connection with FIG. 4. FIG. 4 illustrates a schematic diagram illustrating an example process 400 for configuring a resource set for CI transmission on a PSFCH slot according to embodiments of the present disclosure. As shown in FIG. 4, within a bandwidth part (BWP) 401, a resource pool 410 may be configured for the first device 110, and a portion of the resource pool 410 may be configured for PSFCH transmission, as indicated by 411. The following description on the configuration of the resource set will be given from perspectives of frequency domain, time domain and code domain.

### 1. Example Configuration in Frequency Domain

In some embodiments, the first device 110 may determine, from a radio resource control (RRC) configuration, a set of physical resource blocks (PRBs) for the resource set. The set of PRBs may be counted from an ending PRB of a further resource set configured for a sidelink feedback transmission. With reference to FIG. 4, the set of PRBs for CI transmission may be counted from an ending PRB of the portion 411 for PSFCH transmission, and then the resource set as indicated by 412 may be determined. For example, the set of PRBs may be indicated by a new RRC parameter SL-CI-RB-Set counting from the ending PRB of the RRC parameter sl-PSFCH-RB-Set. Of course, the set of PRBs may be indicated in any other suitable ways.

In some alternative embodiments, the first device 110 may determine, as PRBs of the resource set, a predetermined number of PRBs following PRBs of the further resource set. With reference to FIG. 4, the predetermined number of PRBs following an ending PRB of the portion 411 may be determined by default for CI transmission, and then the resource set as indicated by 412 may be determined.

In some embodiments, the predetermined number may be at least associated with the number of subchannels in a configured resource pool within the BWP and a period of resources for the sidelink feedback transmission in the unit of slots within the configured resource pool. For example, the predetermined number (denoted as N) may be determined by equation (1) below.

$$N = M \cdot {N}_{s u b c h} \cdot {N}_{PSSCH}^{PSFCH} \qquad ( 1 )$$

where N denotes the predetermined number of PRBs for the resource set for CI transmission, M denotes an integer, N_{subch} denotes the number of subchannels in the corresponding resource pool which consists of contiguous PRBs only, and N_{PSSCH}^{PSFCH} denotes the period of PSFCH resource in the unit of slots within the resource pool.

In some embodiments, M equals to 1 for Embodiment 1 as later described, and equals to 1 or 2 for Embodiment 2 as later described. Of course, any other integers are also feasible as the value of M. In some embodiments, N_{subch} may be provided by RRC parameter sl-NumSubchannel, and N_{PSSCH}^{PSFCH} may be provided by RRC parameter sl-PSFCH-Period. Of course, any other suitable ways are also feasible for configuration of N_{subch} and N_{PSSCH}^{PSFCH}.

It is to be understood that the above equation is merely an example, and the predetermined number may be determined in any other suitable ways.

In some alternative embodiments, the first device 110 may determine unused PRBs within a BWP as the resource set. Still with reference to FIG. 4, unused portion (denoted as R_PRB) 420 within the BWP 401 other than the resource pool 410 may be determined for CI transmission, and the unused portion 420 may be determined as the resource set.

### 2. Example Configuration in Time Domain

In some embodiments, the first device 110 may determine the resource set in time domain based on the same symbol position and period as that for a sidelink feedback transmission. For example, the resource set may be configured with the same symbol position and period as PSFCH symbols in the resource pool considering consistent reception/transmission transition. That is, automatic gain control (AGC) and guard symbols may be needed and PSFCH design may be reused.

### 3. Example Configuration in Code Domain

In some embodiments, the first device 110 may determine the resource set in code domain by using an unused code domain resource of a sidelink feedback transmission. For example, the first device 110 may use the unused code domain resource of PSFCH, e.g., cyclic shift pairs that are not used for PSFCH.

In some embodiments, if the number of cyclic shift pairs for the CI is configured with 1, the cyclic shift pair index may be one of 1, 2, 3, 4 and 5 except 0. For example, the cyclic shift pair index may be 3. In some embodiments, if the number of cyclic shift pairs for the CI is configured with 2, the cyclic shift pair index may be two of 1, 2, 4 and 5 except 0 and 3. For example, the cyclic shift pair indexes may be 1 and 4. As another example, the cyclic shift pair indexes may be 2 and 5. In some embodiments, if the number of cyclic shift pairs for the CI is configured with 3, the cyclic shift pair index may be 1, 3 and 5 except 0, 2 and 4. Some examples of code domain configuration are listed in Tables 1 and 2 for illustration. The number of cyclic shift pairs for the CI is denoted by N_{CS}^{PSFCH}, and the value for computing a cyclic shift value is denoted by m₀.

TABLE 1
An Example of Code Domain Configuration for CI Resources

| | m₀ | | | | | |
|---|---|---|---|---|---|---|
| | Cyclic | Cyclic | Cyclic | Cyclic | Cyclic | Cyclic |
| | Shift Pair | Shift Pair | Shift Pair | Shift Pair | Shift Pair | Shift Pair |
| N_{CS}^{PSFCH} | Index 0 | Index 1 | Index 2 | Index 3 | Index 4 | Index 5 |
| 1 | 3 | — | — | — | — | — |
| 2 | 1 | 4 | — | — | — | — |
| 3 | 1 | 3 | 5 | — | — | — |

TABLE 2
Another Example of Code Domain Configuration for CI Resources

| | m₀ | | | | | |
|---|---|---|---|---|---|---|
| | Cyclic | Cyclic | Cyclic | Cyclic | Cyclic | Cyclic |
| | Shift Pair | Shift Pair | Shift Pair | Shift Pair | Shift Pair | Shift Pair |
| N_{CS}^{PSFCH} | Index 0 | Index 1 | Index 2 | Index 3 | Index 4 | Index 5 |
| 1 | 3 | — | — | — | — | — |
| 2 | 2 | 5 | — | — | — | — |
| 3 | 1 | 3 | 5 | — | — | — |

So far, the determination of the resource set is described. It is to be understood that the resource set for CI transmission may be determined in any other suitable ways, and the present disclosure does not limit this aspect. The following description will be given on some examples of the determination of the resource from the resource set in connection with Embodiments 1 and 2.

### Embodiment 1

In this embodiment, the first device 110 may determine, from the resource set, at least one available resource on the first slot, and determine the resource from the at least one available resource based on at least a second identity of the second device and the number of the at least one available resource. In some embodiments, the at least one available resource may comprise multiple available resources. For example, the multiple available resources may be a set of PRBs or a plurality of sets of PRBs. Of course, the at least one available resource may comprise only one available resource, for example, only one PRB.

The resource set may be provided on multiple slots in a period (for example, corresponding to PSFCH slots), and the at least one available resource may be determined from resources in the resource set on the first slot. The first slot is earlier than the second slot with resource collision by a number of slots, and the number of slots is less than a threshold number. The threshold number may be determined as needed. For example, the threshold number may be 2. Of course, any other suitable numbers are also feasible.

In other words, for the slot determination, if a UE detects potential/expected resource conflict on the resources indicated by UE-B's SCI and the inter-UE coordination scheme 2 is requested/indicated by UE-B/higher layer, the UE provides the conflict information in a CI transmission in the resource pool. The UE transmits the CI in a first slot that includes CI resources and is at least a number of slots of the resource pool before a first symbol of the conflicted resources. Some example implementations of Embodiment 1 will be further described in connection with Examples 1, 2 and 3.

### Example 1

In this example, the first device 110 may determine the at least one available resource based on at least a starting resource in the set of resources to be used by the second device 120. Then, the first device 110 may determine the resource from the at least one available resource based on a first identity of the first device 110, the second identity of the second device 120 and the number of the at least one available resource.

In this example, if any devices that satisfying certain conditions or an intended receiver of the second device 120 may become the first device 110, there may be a plurality of first devices 110.

For clarity; the determination of the at least one available resource will be described with reference to FIGS. 5A and 5B. FIG. 5A illustrates a schematic diagram illustrating an example process 500A for determining at least one available resource from the resource set according to embodiments of the present disclosure. In the example of FIG. 5A, the first device 110 may determine the at least one available resource based on only a starting resource in the set of resources to be used by the second device 120.

In the example of FIG. 5A, assuming that the second device 120's SCI indicates a set of resources 510 comprising resources 501 and 502, and the third device 130's SCI indicates another set of resources 520 comprising resources 502, 503 and 504. The first device 110 knows the resource collision between the second and third devices 120 and 130.

As shown in FIG. 5A, the resource 501 on the second slot is associated with a set of PRBs 511 on the first slot, the resource 502 on the second slot is associated with a set of PRBs 512 on the first slot, the resource 503 on the second slot is associated with a set of PRBs 513 on the first slot, and the resource 504 on the second slot is associated with a set of PRBs 514 on the first slot.

As the starting resource in the set of resources 510 is resource 501, the first device 110 may determine the PRBs 511 corresponding to the resource 501 as the at least one available resource for CI transmission to the second device 120. As the starting resource in the other set of resources 520 is resource 502, the first device 110 may determine the PRBs 512 corresponding to the resource 502 as the at least one available resource for CI transmission to the third device 130.

FIG. 5B illustrates a schematic diagram illustrating an example process 500B for determining at least one available resource from the resource set according to embodiments of the present disclosure. In the example of FIG. 5B, the first device 110 may determine the at least one available resource based on all resources in the set of resources to be used by the second device 120.

In the example of FIG. 5B, also assuming that the second device 120's SCI indicates a set of resources 510 comprising resources 501 and 502, and the third device 130's SCI indicates another set of resources 520 comprising resources 502, 503 and 504. The first device 110 knows the resource collision between the second and third devices 120 and 130.

As shown in FIG. 5B, the resource 501 on the second slot is associated with a set of PRBs 511 on the first slot, the resource 502 on the second slot is associated with a set of PRBs 512 on the first slot, the resource 503 on the second slot is associated with a set of PRBs 513 on the first slot, and the resource 504 on the second slot is associated with a set of PRBs 514 on the first slot.

As the set of resources 510 comprise the resources 501 and 502, the first device 110 may determine the PRBs 511 and 512 corresponding to the resources 501 and 502 as the at least one available resource for CI transmission to the second device 120. As the other set of resources 520 comprise the resources 502, 503 and 504, the first device 110 may determine the PRBs 512, 513 and 514 corresponding to the resources 502, 503 and 504 as the at least one available resource for CI transmission to the third device 130.

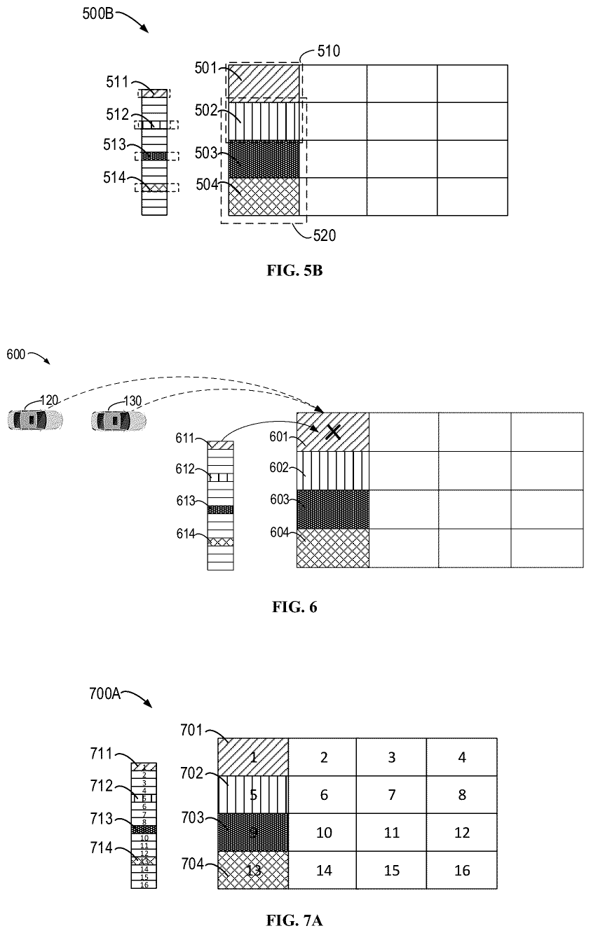

Upon determination of the at least one available resource, the first device 110 may determine the resource from the at least one available resource based on a first identity of the first device 110, the second identity of the second device 120 and the number of the at least one available resource. For clarity, the determination of the resource from the at least one available resource will be described with reference to FIG. 6. FIG. 6 illustrates a schematic diagram illustrating an example process 600 for determining a resource from the at least one available resource for CI transmission according to embodiments of the present disclosure. In the example of FIG. 6, assuming that the second device 120's SCI indicates a resource 601, and the third device 130's SCI also indicates the resource 601. The first device 110 knows the resource collision between the second and third devices 120 and 130.

As shown in FIG. 6, the resource 601 on the second slot is associated with a set of PRBs 611 on the first slot, the resource 602 on the second slot is associated with a set of PRBs 612 on the first slot, the resource 603 on the second slot is associated with a set of PRBs 613 on the first slot, and the resource 604 on the second slot is associated with a set of PRBs 614 on the first slot.

In this case, the available resource for CI transmission to the second device 120 and the available resource for CI transmission to the third device 130 may be both determined as PRBs 611. For example, an index (denoted as R) of the resource for CI transmission may be determined from equation (2) below.

$$R = ( B\_ID + A\_ID ) mode R\_CI \qquad ( 2 )$$

where R denotes the index of the resource for CI transmission, B_ID denotes an identity (i.e., the second identity) of the second device 120, A_ID denotes an identity (i.e., the first identity) of the first device 110, and R_CI denotes the number of the at least one available resource.

In some embodiments, B_ID may be used to separate CI resources for different devices in the conflicted resource. In some embodiments, A_ID may be preconfigured or configured from a higher layer, e.g., coordination ID. In some embodiments, R_CI may be the number of CI resources available for multiplexing CI information in a CI transmission. It is to be understood that the above equation is merely an example, and any other suitable ways are also feasible.

In this way, different PRBs in the same set of PRBs 611 may be determined for respective CI transmissions to the second and third devices 120 and 130.

### Example 2

In this example, the first device 110 may determine, as the at least one available resource, at least one unused resource configured for transmission of sidelink feedback information. Then, the first device 110 may determine the resource from the at least one available resource (i.e., the at least one unused resource) based on a first identity of the first device 110, the second identity of the second device 120 and the number of the at least one available resource.

In some embodiments, the at least one unused resource may comprise multiple unused resources, for example, multiple PRBs. Of course, the at least one unused resource may comprise only one unused resource, for example, only one PRB.

In this example, assuming that only an intended receiver of the second device 120 may become the first device 110. For unicast, there may be only one first device 110, and CI resource may be the unused PSFCH resource.

For example, an index (denoted as R) of the resource for CI transmission may be determined from equation (3) below.

$$R = ( B\_ID + A\_ID ) mode R\_PSFCH \qquad ( 3 )$$

where R denotes the index of the resource for CI transmission, B_ID denotes an identity (i.e., the second identity) of the second device 120, A_ID denotes an non-zero identity (i.e., the first identity) of the first device 110, and R_PSFCH denotes the PSFCH resource set R_{PRB, CS}^{PSFCH} defined in TS 38.213.

In some embodiments, B_ID may be used to separate CI resources for different devices in the conflicted resource. In some embodiments, A_ID may be preconfigured or configured from a higher layer, e.g., coordination ID. It is to be understood that the above equation is merely an example, and any other suitable ways are also feasible.

### Example 3

In this example, the first device 110 may determine the at least one available resource based on at least a starting resource in the set of resources to be used by the second device 120. Then, the first device 110 may determine the resource from the at least one available resource based on the second identity of the second device 120 and the number of the at least one available resource.

In this example, if any devices that satisfying certain conditions or an intended receiver of the second device 120 may become the first device 110, there may be a plurality of first devices 110.

In this example, the determination of the at least one available resource is similar with that described in Example 1 with reference to FIGS. 5A and 5B, and thus is omitted here.

For unicast or groupcast or broadcast case, upon determination of the at least one available resource, the first device 110 may determine the resource from the at least one available resource based on only the second identity of the second device 120 and the number of the at least one available resource. For example, an index (denoted as R) of the resource for CI transmission may be determined from equation (4) below.

$$R = B\_ID mode R\_CI \qquad ( 4 )$$

where R denotes the index of the resource for CI transmission, B_ID denotes an identity (i.e., the second identity) of the second device 120, and R_CI denotes the number of the at least one available resource.

In some embodiments, B_ID may be used to separate CI resources for different devices in the conflicted resource. In some embodiments, R_CI may be the number of CI resources available for multiplexing CI information in a CI transmission. It is to be understood that the above equation is merely an example, and any other suitable ways are also feasible.

In this way, the plurality of first devices 110 may share the same CI resources, and resource consumption may be reduced.

### Embodiment 2

In this embodiment, the first device 110 may determine, based on a set of indexes corresponding to the set of resources, a set of target resources on the first slot, and then determine the set of target resources as the determined resource for CI transmission. In other words, to make the second device 120 has the same understanding about the resource collision as the first device 110, for unicast or groupcast or broadcast case, an index of the resource for CI transmission is determined by an index of the collided resource.

For example, the index of the CI resource is equal to the index of the collided resource. In this way, each resource has a separate collided status (acknowledgement (ACK) or non-acknowledgement (NACK)).

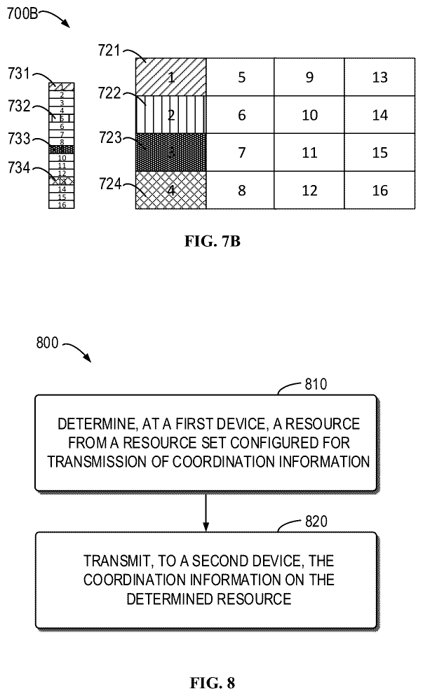

FIG. 7A illustrates a schematic diagram illustrating another example process 700A for determining a resource for CI transmission according to embodiments of the present disclosure. As shown in FIG. 7A, the collided resources 701, 702, 703 and 704 on the second slot have the indexes 1, 5, 9 and 13 respectively. Then resources 711, 712, 713 and 714 with indexes 1, 5, 9 and 13 respectively on the first slot are determined for CI transmission.

FIG. 7B illustrates a schematic diagram illustrating still another example process 700B for determining a resource for CI transmission according to embodiments of the present disclosure. As shown in FIG. 7B, the collided resources 721, 722, 723 and 724 on the second slot have the indexes 1, 2, 3 and 4 respectively. Then resources 731, 732, 733 and 734 with indexes 1, 2, 3 and 4 respectively on the first slot are determined for CI transmission.

It is to be understood that the above examples of FIGS. 7A and 7B are merely for illustration, and do not make limitation for the present disclosure. In this way, less complexity and reduced resource consumption may be achieved.

So far, the determination of the resource for CI transmission is described in connection with Embodiments 1 and 2. It should be noted that any other suitable ways are also feasible for the determination of the resource for CI transmission.

Returning to FIG. 3, upon determination of the resource for CI transmission, the first device 110 may transmit 320 the CI to the second device 120 on the determined resource. The transmission of the CI will be detailed below from perspectives of CI contents, prioritization between CI and sidelink feedback information, transmit limits in capability and power, and half-duplex between CI and sidelink feedback information.

### 1. Example Implementation of CI Contents

In some embodiments, for example for Example 1 or 2 as described above, the first device 110 may transmit a first sequence that indicates the presence of the collision if the collision is present or to be present on the set of resources, and transmit a second sequence that indicates the absence of the collision if no collision is present or to be present on the set of resources. For example, when expected or future resource collision is detected, the first device 110 may transmit a sequence “1/ACK” in the determined resource. When expected or future resource collision is not detected, the first device 110 may transmit a sequence “0/NACK” in the determined resource. As an alternative, the first device 110 may transmit a sequence “0/NACK” in the determined resource when expected or future resource collision is detected, and transmit a sequence “1/ACK” in the determined resource when expected or future resource collision is not detected.

In some embodiments, for example for Example 3 as described above, the first device 110 may transmit a sequence on the determined resource if the collision is present or to be present on the set of resources, and transmit no sequence on the determined resource. For example, when expected or future resource collision is detected, the first device 110 may transmit a sequence “1/ACK” or “0/NACK” in the determined resource. When expected or future resource collision is not detected, the first device 110 may transmit nothing in the determined resource. As an alternative, the first device 110 may transmit no sequence in the determined resource when expected or future resource collision is detected, and transmit a sequence “1/ACK” or “0/NACK” in the determined resource when expected or future resource collision is not detected.

In some embodiments, for example for Embodiment 2 as described above, the first device 110 may transmit a sequence on a target resource in the set of target resources corresponding to a first resource if the collision is present or to be present on the first resource, and transmit no sequence on a target resource in the set of target resources corresponding to a first resource if no collision is present or to be present on the first resource. For example, when expected or future resource collision is detected in subchannel [n], the first device 110 may transmit a sequence “1/ACK” or “0/NACK” in a CI resource with an index [n]. For subchannel [n] where expected or future resource collision is not detected, the first device 110 may transmit nothing in a CI resource with an index [n].

### 2. Prioritization Between CI and Sidelink Feedback Information

As the CI resources may be configured at the same slots of PSFCH resources, CI and sidelink feedback information may be both transmitted in one occasion. To achieve proper transmission and reception behavior on CI and sidelink feedback information, prioritization rules between CI and sidelink feedback information needs to be defined so as to determine which PSFCH and CI transmissions should be transmitted and received in one occasion. Embodiments of the present disclosure provide a solution for the prioritization.

In some embodiments for the solution, the priority of the sidelink feedback information may be higher than the priority of the CI. In this case, PSFCH transmission or reception may always have a higher priority than CI transmission or reception.

In some alternative embodiments, the priority of the coordination information may correspond to a layer 1 (L1) priority of the second device 120. In this case, the priority value in associated reservation SCI from the second device 120 may be compared with the priority value of PSFCH defined in TS 38.213.

In some alternative embodiments, the priority of the CI may be higher than the priority of the sidelink feedback information. That is, PSFCH transmission or reception may always have a higher priority than CI transmission or reception.

Of course, any other suitable ways are also feasible for achieving the prioritization, and the present disclosure does not limit this aspect.

### 3. Transmit Limits in Capability and Power

In some embodiments, the first device 110 may transmit the CI on an occasion so that the total number of first transmission (also referred to CI transmission here) of CI and second transmission (also referred to PSFCH transmission here) of sidelink feedback information on the occasion is smaller than or equal to a threshold total number and the total power of the first and second transmissions on the occasion is smaller than or equal to a threshold total power. In other words, on a resource pool in PSFCH and CI transmission occasion, the first device 110 shall ensure that the total number of PSFCH and CI transmissions respectively does not exceed the capability limits firstly and then that total power of the PSFCH and CI transmissions does not exceed a maximum power limit.

In some embodiments, if the total number is smaller than or equal to the threshold total number, the first device 110 may determine whether the total power is smaller than or equal to a threshold total power. If the total power is smaller than or equal to a threshold total power, the first device 110 may perform the first and second transmissions on the occasion. If the total power is larger than the threshold total power, the first device 110) may perform, based on priorities of the CI and the sidelink feedback information, a first number of transmissions among the first and second transmissions, the total power of the first number of transmissions being smaller than or equal to the threshold total power.

For example, if the total number of PSFCH transmission and CI transmission is not larger than the capability limit Mmax, and if the total power of PSFCH transmission and CI transmission does not exceed the max power limit, the first device 110 may transmit all the PSFCH and CI on the occasion. If the total power of PSFCH transmission and CI transmission exceeds the maximum power limit, the first device 110 may transmit the largest N PSFCH and CI based on an ascending priority order as previously described to ensure total power of the N PSFCH and CI does not exceed a maximum power limit.

In some embodiments, if the total number is larger than the threshold total number, the first device 110 may determine, based on priorities of the CI and the sidelink feedback information, the threshold total number of transmissions from the first and second transmissions on the occasion. If the total power of the threshold total number of transmissions is smaller than or equal to the threshold total power, the first device may perform the threshold total number of transmissions. If the total power of the threshold total number of transmissions is larger than the threshold total power, the first device 110 may perform, based on priorities of the CI and the sidelink feedback information, a second number of transmissions among the threshold total number of transmissions, the total power of the second number of transmissions being smaller than or equal to the threshold total power.

For example, if the total number of PSFCH transmission and CI transmission is larger than the capability limit Mmax, the first device 110 may determine Mmax transmission of PSFCH transmission and CI transmission based on ascending priority order as previously described. If the total power of PSFCH transmission and CI transmission does not exceed the maximum power limit, the first device 110 may transmits all the PSFCH and CI. If the total power of PSFCH transmission and CI transmission exceeds the maximum power limit, the first device 110 may transmit the largest N PSFCH and CI based on an ascending priority order as previously described to ensure total power of the N PSFCH and CI does not exceed a maximum power limit.

### 4. Half-Duplex Between CI and Sidelink Feedback Information

According to embodiments of the present disclosure, the first device 110 needs to avoid the simultaneous transmission and reception in the same PSFCH/CI occasion. In other words, half-duplex between CI and PSFCH needs to be achieved.

In some embodiments, if the transmission of the CI is overlapped in time domain with a reception of sidelink feedback information from a third device, the first device 110 may perform the reception of the sidelink feedback information or the transmission of the CI based on priorities of the sidelink feedback information and the CI. For example, if the sidelink feedback information has a higher priority than the CI, the first device 110 may perform the reception of the sidelink feedback information and cancel the transmission of the CI. If the CI has a higher priority than the sidelink feedback information, the first device 110 may perform the transmission of the CI and cancel the reception of the sidelink feedback information.

It is to be understood that the third device may be any device other than the first device 110. The prioritization rules may be defined as previously described.

In some embodiments, if further sidelink feedback information is to be transmitted to a fourth device and that the transmission of the further sidelink feedback information is overlapped in time domain with a reception of further CI from a fifth device, the first device 110 may performing the transmission of the further sidelink feedback information or the reception of the further CI based on priorities of the further sidelink feedback information and the further CI. For example, if the further sidelink feedback information has a higher priority than the further CI, the first device 110 may perform the reception of the further sidelink feedback information and cancel the transmission of the further CI. If the further CI has a higher priority than the further sidelink feedback information, the first device 110 may perform the transmission of the further CI and cancel the reception of the further sidelink feedback information.

It is to be understood that the fourth device or fifth device may be any device other than the first device 110. The prioritization rules may be defined as previously described.

Again returning to FIG. 3, upon reception of the CI, the second device 120 may determine 330, based on the CI, whether the set of resources to be used in future are available. In some embodiments, if a first sequence indicating the presence of the collision is received from a resource in the at least one available resource, the second device 120 may determine that the set of resources are unavailable. If a second sequence indicating the absence of the collision is received from each resource in the at least one available resource, the second device 120 may determine that the set of resources are available.

In some embodiments where the determined resource comprises at least one available resource determined from the resource set for CI transmission based on at least a starting resource in the collided resources, if a sequence is received from a resource in the at least one available resource, the second device 120 may determine that the set of resources are unavailable. If no sequence is received from each resource in the at least one available resource, the second device 120 may determine that the set of resources are available. In this way, reduced resource consumption may be achieved.

In some embodiments, the second device 120 may determine that the resource is conflicted when the number or the ratio of received conflicted indications exceeds a pre-configured or configured threshold because the second device 120 knows whether it's ACK or NACK but does not know from which device the ACK/NACK indication comes. In some embodiments, for groupcast, if only one or more intended receivers of the second device 120 may become first device 110, the first devices within a group may be indicated or enabled by a high layer to have a proper quantity of first devices. In this way, more CI may be used for the second device 120 to determine final CI.

In some embodiments where the determined resource comprises at least one unused resource configured for transmission of sidelink feedback information, if a first sequence indicating the presence of the collision is received as the CI, the second device 120 may determine that the set of resources are unavailable. If a second sequence indicating the absence of the collision is received as the CI, the second device 120 may determine that the set of resources are available.

In some embodiments where the determined resource comprises a set of target resources determined based on a set of indexes corresponding to the set of resources, if a sequence is received from a resource in the set of target resources, the second device 120 may determine that the set of resources are unavailable. If no sequence is received from each resource in the set of target resources, the second device 120 may determine that the set of resources are available. For example, the second device 120 may determine the reserved subchannels n to n+x is conflicted if CI is received in at least one of the CI resources n to n+x. In this way, a less complexity and reduced resource consumption may be achieved.

So far, the process of communication for sidelink transmission according to embodiments of the present application is described. With the process, CI may be transmitted in proper resources with a less resource consumption and reduced complexity.

### Example Implementation of Methods

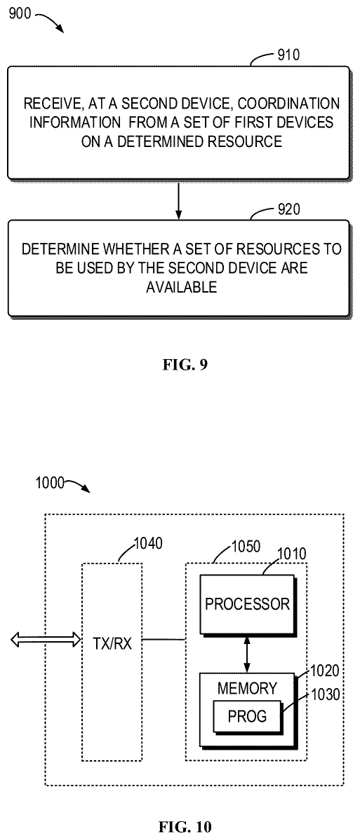

Accordingly, embodiments of the present disclosure provide methods of communication implemented at a first device serving as a CI transmitter and a second device serving as a CI receiver. These methods will be described below with reference to FIGS. 8 to 9.

FIG. 8 illustrates an example method 800 of communication implemented at a first device serving as a CI transmitter in accordance with some embodiments of the present disclosure. For example, the method 800 may be performed at the first device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the first device 110 determines a resource from a resource set configured for transmission of CI, the CI indicating the presence or absence of a collision on a set of resources to be used by the second device 120, a first slot for the determined resource being earlier than a second slot for the set of resources by a number of slots, the number of slots being less than a threshold number. In some embodiments, the first device 110 may determine, from the resource set, at least one available resource on the first slot, and determine the resource from the at least one available resource based on at least a second identity of the second device 120 and the number of the at least one available resource.

In some embodiments, the first device 110 may determine the at least one available resource based on at least a starting resource in the set of resources. In these embodiments, the first device 110 may determine the resource by determining the resource from the at least one available resource based on a first identity of the first device 110, the second identity of the second device 120 and the number of the at least one available resource, as exemplified in Example 1 of Embodiment 1.

In some embodiments, the first device 110 may determine at least one unused resource configured for transmission of sidelink feedback information as the at least one available resource. In these embodiments, the first device 110 may determine the resource by determining the resource from the at least one available resource based on a first identity of the first device 110, the second identity of the second device 120, and the number of the at least one unused resource, as exemplified in Example 2 of Embodiment 1.

In some embodiments, the first device 110 may determine the at least one available resource based on at least a starting resource in the set of resources. In these embodiments, the first device 110 may determine the resource by determining the resource from the at least one available resource based on the second identity of the second device 120 and the number of the at least one available resource, as exemplified in Example 3 of Embodiment 1.

In some alternative embodiments, the first device 110 may determine, based on a set of indexes corresponding to the set of resources, a set of target resources on the first slot, and determine the set of target resources as the determined resource, as exemplified in Embodiment 2.

In some embodiments, the first device 110 may determine the resource set in frequency domain by determining, from a RRC configuration, a set of PRBs for the resource set, the set of PRBs being counted from an ending PRB of a further resource set, the further resource set being configured for a sidelink feedback transmission.

In some alternative embodiments, the first device 110 may determine the resource set in frequency domain by determining, as PRBs of the resource set, a predetermined number of PRBs following PRBs of the further resource set. In some embodiments, the predetermined number may be at least associated with the number of subchannels in a configured resource pool within the BWP and a period of resources for the sidelink feedback transmission in the unit of slots within the configured resource pool.

In some alternative embodiments, the first device 110 may determine the resource set in frequency domain by determining unused PRBs within a BWP as the resource set.

In some embodiments, the first device 110 may determine the resource set in time domain based on the same symbol position and period as that for a sidelink feedback transmission. In some embodiments, the first device 110 may determine the resource set in code domain by using an unused code domain resource of a sidelink feedback transmission.

At block 820, the first device 110 transmits, to the second device 120, the CI on the determined resource. In some embodiments, if the collision is present or to be present on the set of resources, the first device 110 may transmit a first sequence that indicates the presence of the collision, and if no collision is present or to be present on the set of resources, the first device 110 may transmit a second sequence that indicates the absence of the collision. In some embodiments, if the collision is present or to be present on the set of resources, the first device 110 may transmit a sequence on the determined resource, and if no collision is present or to be present on the set of resources, the first device 110 may transmit no sequence on the determined resource.

In some embodiments, the first device 110 may transmit the CI on an occasion so that the total number of first transmission of CI and second transmission of sidelink feedback information on the occasion is smaller than or equal to a threshold total number and the total power of the first and second transmissions on the occasion is smaller than or equal to a threshold total power.

In some embodiments, if the total number is smaller than or equal to the threshold total number, the first device 110 may determine whether the total power is smaller than or equal to a threshold total power; if the total power is smaller than or equal to a threshold total power, the first device 110 may perform the first and second transmissions on the occasion; and if the total power is larger than the threshold total power, the first device 110 may perform, based on priorities of the CI and the sidelink feedback information, a first number of transmissions among the first and second transmissions, the total power of the first number of transmissions being smaller than or equal to the threshold total power.

In some embodiments, if the total number is larger than the threshold total number, the first device 110 may determine, based on priorities of the CI and the sidelink feedback information, the threshold total number of transmissions from the first and second transmissions on the occasion; if the total power of the threshold total number of transmissions is smaller than or equal to the threshold total power, the first device 110 may perform the threshold total number of transmissions; and if the total power of the threshold total number of transmissions is larger than the threshold total power, the first device 110 may perform, based on priorities of the CI and the sidelink feedback information, a second number of transmissions among the threshold total number of transmissions, the total power of the second number of transmissions being smaller than or equal to the threshold total power.

In some embodiments where the transmission of the CI is overlapped in time domain with a reception of sidelink feedback information from a third device, the first device 110 may perform the reception of the sidelink feedback information or the transmission of the CI based on priorities of the sidelink feedback information and the CI. In some embodiments, the priority of the sidelink feedback information may be higher than the priority of the CI. In some embodiments, the priority of the CI may correspond to a L1 priority of the second device 120. In some embodiments, the priority of the CI is higher than the priority of the sidelink feedback information.

In some embodiments where if further sidelink feedback information is to be transmitted to a fourth device and that the transmission of the further sidelink feedback information is overlapped in time domain with a reception of further CI from a fifth device, the first device 110 may perform the transmission of the further sidelink feedback information or the reception of the further CI based on priorities of the further sidelink feedback information and the further CI. In some embodiments, the priority of the further sidelink feedback information may be higher than the priority of the further CI. In some embodiments, the priority of the further CI corresponds to a L1 priority of the second device 120. In some embodiments, the priority of the further CI may be higher than the priority of the further sidelink feedback information.

With the method of FIG. 8, resources for CI transmission may be designed and CI may be transmitted in proper resources.

FIG. 9 illustrates an example method 900 of communication implemented at a second device serving as a CI receiver in accordance with some embodiments of the present disclosure. For example, the method 900 may be performed at the second device 120 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the second device 120 receives CI from a set of first devices (for example, the first device 110) on a determined resource associated with a set of resources to be used by the second device, the CI indicating the presence or absence of a collision on the set of resources, a first slot for the determined resource being earlier than a second slot for the set of resources by a number of slots, the number of slots being less than a threshold number.

At block 920, the second device 120 determines whether the set of resources are available based on the CI.

In some embodiments, the determined resource may comprise at least one available resource determined from a resource set based on at least a starting resource in the set of resources, the resource set being configured for transmission of CI. In these embodiments, if a sequence is received from a resource in the at least one available resource, the second device 120 may determine that the set of resources are unavailable, and if no sequence is received from each resource in the at least one available resource, the second device 120 may determine that the set of resources are available.

In some embodiments, the determined resource may comprise at least one unused resource configured for transmission of sidelink feedback information. In these embodiments, if a first sequence indicating the presence of the collision is received as the coordination information, the second device 120 may determine that the set of resources are unavailable; and if a second sequence indicating the absence of the collision is received as the coordination information, the second device 120 may determine that the set of resources are available.

In some embodiments, the determined resource may comprise a set of target resources determined based on a set of indexes corresponding to the set of resources. In these embodiments, if a sequence is received from a resource in the set of target resources, the second device 120 may determine that the set of resources are unavailable; and if no sequence is received from each resource in the set of target resources, the second device 120 may determine that the set of resources are available.

With the method of FIG. 9, CI may be received in proper resources and the collision of reserved resources may be known in time. In this way, inter-UE coordination may be enhanced and resource utilization may be improved in sidelink communication.

### Example Implementation of Device

FIG. 10 is a simplified block diagram of a device 1000 that is suitable for implementing embodiments of the present disclosure. The device 1000 can be considered as a further example implementation of the first device 110 or the second device 120 as shown in FIG. 1. Accordingly, the device 1000 can be implemented at or as at least a part of the first device 110 or the second device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 2 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device (a first device) comprises a circuitry configured to: determine a resource from a resource set configured for transmission of CI, the CI indicating the presence or absence of a collision on a set of resources to be used by a second device, a first slot for the determined resource being earlier than a second slot for the set of resources by a number of slots, the number of slots being less than a threshold number; and transmit the CI to the second device on the determined resource.

In some embodiments, the circuitry may be configured to determine the resource by determining, from the resource set, at least one available resource on the first slot; and determining the resource from the at least one available resource based on at least a second identity of the second device and the number of the at least one available resource.

In some embodiments, the circuitry may be configured to determine the at least one available resource by determining the at least one available resource based on at least a starting resource in the set of resources. In these embodiments, the circuitry may be configured to determine the resource by determining the resource from the at least one available resource based on a first identity of the first device, the second identity of the second device and the number of the at least one available resource.

In some embodiments, the circuitry may be configured to determine the at least one available resource by determining at least one unused resource configured for transmission of sidelink feedback information as the at least one available resource. In these embodiments, the circuitry may be configured to determine the resource by determining the resource from the at least one available resource based on a first identity of the first device, the second identity of the second device, and the number of the at least one unused resource.

In some embodiments, the circuitry may be configured to transmit the coordination information by in accordance with a determination that the collision is present or to be present on the set of resources, transmitting a first sequence that indicates the presence of the collision; and in accordance with a determination that no collision is present or to be present on the set of resources, transmitting a second sequence that indicates the absence of the collision.

In some embodiments, the circuitry may be configured to determine the at least one available resource by determining the at least one available resource based on at least a starting resource in the set of resources. In these embodiments, the circuitry may be configured to determine the resource by determining the resource from the at least one available resource based on the second identity of the second device and the number of the at least one available resource. In some embodiments, the circuitry may be configured to transmit the coordination information by in accordance with a determination that the collision is present or to be present on the set of resources, transmitting a sequence on the determined resource; and in accordance with a determination that no collision is present or to be present on the set of resources, transmitting no sequence on the determined resource.

In some embodiments, the circuitry may be configured to determine the resource by determining, based on a set of indexes corresponding to the set of resources, a set of target resources on the first slot; and determining the set of target resources as the determined resource. In these embodiments, the circuitry may be configured to transmit the coordination information by in accordance with a determination that the collision is present or to be present on a first resource in the set of resources, transmitting a sequence on a target resource in the set of target resources corresponding to the first resource; and in accordance with a determination that no collision is present or to be present on a first resource in the set of resources, transmitting no sequence on a target resource in the set of target resources corresponding to the first resource.

In some embodiments, the circuitry may be further configured to: determine the resource set in frequency domain by at least one of the following: determining, from a RRC configuration, a set of PRBs for the resource set, the set of PRBs being counted from an ending PRB of a further resource set, the further resource set being configured for a sidelink feedback transmission; determining, as PRBs of the resource set, a predetermined number of PRBs following PRBs of the further resource set; or determining unused PRBs within a BWP as the resource set. In some embodiments, the predetermined number may be at least associated with the number of subchannels in a configured resource pool within the BWP and a period of resources for the sidelink feedback transmission in the unit of slots within the configured resource pool.

In some embodiments, the circuitry may be further configured to determine the resource set in time domain based on the same symbol position and period as that for a sidelink feedback transmission. In some embodiments, the circuitry may be further configured to determine the resource set in code domain by using an unused code domain resource of a sidelink feedback transmission.

In some embodiments, the circuitry may be configured to transmit the CI by transmitting the CI on an occasion so that the total number of first transmission of CI and second transmission of sidelink feedback information on the occasion is smaller than or equal to a threshold total number and the total power of the first and second transmissions on the occasion is smaller than or equal to a threshold total power.

In some embodiments, the circuitry may be configured to transmit the coordination information on the occasion by in accordance with a determination that the total number is smaller than or equal to the threshold total number, determining whether the total power is smaller than or equal to a threshold total power; in accordance with a determination that the total power is smaller than or equal to a threshold total power, performing the first and second transmissions on the occasion; and in accordance with a determination that the total power is larger than the threshold total power, performing, based on priorities of the CI and the sidelink feedback information, a first number of transmissions among the first and second transmissions, the total power of the first number of transmissions being smaller than or equal to the threshold total power.

In some embodiments, the circuitry may be configured to transmit the coordination information on the occasion by in accordance with a determination that the total number is larger than the threshold total number, determining, based on priorities of the coordination information and the sidelink feedback information, the threshold total number of transmissions from the first and second transmissions on the occasion; in accordance with a determination that the total power of the threshold total number of transmissions is smaller than or equal to the threshold total power, performing the threshold total number of transmissions; and in accordance with a determination that the total power of the threshold total number of transmissions is larger than the threshold total power, performing, based on priorities of the CI and the sidelink feedback information, a second number of transmissions among the threshold total number of transmissions, the total power of the second number of transmissions being smaller than or equal to the threshold total power.

In some embodiments, the circuitry may be further configured to: in accordance with a determination that the transmission of the coordination information is overlapped in time domain with a reception of sidelink feedback information from a third device, perform the reception of the sidelink feedback information or the transmission of the CI based on priorities of the sidelink feedback information and the CI. In some embodiments, the priority of the sidelink feedback information may be higher than the priority of the CI. In some embodiments, the priority of the CI may correspond to a L1 priority of the second device. In some embodiments, the priority of the CI may be higher than the priority of the sidelink feedback information.

In some embodiments, the circuitry may be further configured to: in accordance with a determination that further sidelink feedback information is to be transmitted to a fourth device and that the transmission of the further sidelink feedback information is overlapped in time domain with a reception of further CI from a fifth device, perform the transmission of the further sidelink feedback information or the reception of the further CI based on priorities of the further sidelink feedback information and the further CI. In some embodiments, the priority of the further sidelink feedback information may be higher than the priority of the further CI. In some embodiments, the priority of the further coordination information may correspond to a L1 priority of the second device. In some embodiments, the priority of the further CI may be higher than the priority of the further sidelink feedback information.

In some embodiments, a terminal device (a second device) comprises a circuitry configured to: receive CI from a set of first devices on a determined resource associated with a set of resources to be used by the second device, the CI indicating the presence or absence of a collision on the set of resources, a first slot for the determined resource being earlier than a second slot for the set of resources by a number of slots, the number of slots being less than a threshold number; and determine, based on the CI, whether the set of resources are available.

In some embodiments, the determined resource may comprise at least one available resource determined from a resource set based on at least a starting resource in the set of resources, the resource set being configured for transmission of CI. In these embodiments, the circuitry may be configured to determine whether the set of resources are available by in accordance with a determination that a sequence is received from a resource in the at least one available resource, determining that the set of resources are unavailable; and in accordance with a determination that no sequence is received from each resource in the at least one available resource, determining that the set of resources are available.

In some embodiments, the determined resource may comprise at least one unused resource configured for transmission of sidelink feedback information. In these embodiments, the circuitry may be configured to determine whether the set of resources are available by in accordance with a determination that a first sequence indicating the presence of the collision is received as the CI, determining that the set of resources are unavailable; and in accordance with a determination that a second sequence indicating the absence of the collision is received as the CI, determining that the set of resources are available.

In some embodiments, the determined resource may comprise a set of target resources determined based on a set of indexes corresponding to the set of resources. In these embodiments, the circuitry may be configured to determine whether the set of resources are available by in accordance with a determination that a sequence is received from a resource in the set of target resources, determining that the set of resources are unavailable; and in accordance with a determination that no sequence is received from each resource in the set of target resources, determining that the set of resources are available.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-31. (canceled)

32. A first user equipment (UE) comprising:
one or more memories storing instructions; and
one or more processors configured to process the instructions to control the first UE to:
based on a comparison between a first threshold value and a total number of first physical sidelink feedback channel (PSFCH) with Hybrid Automatic Repeat Request-ACKnowledgement (HARQ-ACK) information and second PSFCH with conflict information, and a comparison between a second threshold value and a total power of the first PSFCH with the HARQ-ACK information and the second PSFCH with the conflict information:
determine whether to use a first priority related to the first PSFCH with the HARQ-ACK information and a second priority related to the second PSFCH with the conflict information for determining a number of simultaneous PSFCH transmissions of the first PSFCH with the HARQ-ACK information and the second PSFCH with the conflict information.

33. The first UE according to claim 32, wherein
based on a determination that the total number of the first PSFCH with the HARQ-ACK information and the second PSFCH with the conflict information is smaller than or equal to the first threshold, and a determination that the total power of the first PSFCH with the HARQ-ACK information and the second PSFCH with the conflict information is smaller than or equal to the second threshold:
the one or more processors is configured to process the instructions to control the first UE to:
determine the number of simultaneous PSFCH transmissions of the first PSFCH with the HARQ-ACK information and the second PSFCH with the conflict information.

34. The first UE according to claim 32, wherein
based on a determination that the total number of the first PSFCH with the HARQ-ACK information and the second PSFCH with the conflict information is smaller than or equal to the first threshold, and a determination that the total power of the first PSFCH with the HARQ-ACK information and the second PSFCH with the conflict information is greater than the second threshold, or
based on a determination that the total number of the first PSFCH with the HARQ-ACK information and the second PSFCH with the conflict information is greater than the first threshold, and a determination that the total power of the first PSFCH with the HARQ-ACK information and the second PSFCH with the conflict information is smaller than or equal to the second threshold, or
based on a determination that the total number of the first PSFCH with the HARQ-ACK information and the second PSFCH with the conflict information is greater than the first threshold, and a determination that the total power of the first PSFCH with the HARQ-ACK information and the second PSFCH with the conflict information is greater than the second threshold:
the one or more processors is configured to process the instructions to control the first UE to:
determine, based on an ascending order of the first priority related to the first PSFCH with the HARQ-ACK information and an ascending order of the second priority related to the second PSFCH with the conflict information, the number of simultaneous PSFCH transmissions of the first PSFCH with the HARQ-ACK information and the second PSFCH with the conflict information.

35. The first UE according to claim 32, wherein
based on simultaneous transmission and reception of the first PSFCH with the HARQ-ACK information and the second PSFCH with the conflict information in a PUSCH transmission occasion:
the first priority related to the first PSFCH with the HARQ-ACK information is always higher than the second priority related to the second PSFCH with the conflict information.

36. The first UE according to claim 32, wherein
the second priority, related to the second PSFCH with the conflict information, corresponds to a priority value determined by a corresponding Sidelink Control Information (SCI).

37. The first UE according to claim 32, wherein
the one or more processors is configured to process the instructions to control the first UE to:
communicate with a second UE via sidelink channel, and
determine, based on an identity of the second UE and a number of at least one first PSFCH resource available for multiplexing the conflict information in the second PSFCH, an index of one of the at least one first PSFCH resource for the second PSFCH with the conflict information.

38. The first UE according to claim 37, wherein
the index of one of the at least one first PSFCH resource for the second PSFCH with the conflict information is represented by a formula:
$$R = B\_ID mod R\_CI ,$$
wherein
R denotes the index of one of the at least one first PSFCH resource for the second PSFCH with the conflict information,
B_ID denotes the identity of the second UE, and
R_CI denotes the number of the at least one first PSFCH resource available for multiplexing the conflict information in the second PSFCH.

39. The first UE according to claim 37, wherein
the one or more processors is configured to process the instructions to control the first UE to:
transmit the second PSFCH with the conflict information in a first slot, wherein
the first slot includes the at least one first PSFCH resource, and
the first slot is at least one slots of a resource pool before a resource associated with the conflict information.

40. The first UE according to claim 37, wherein
for a case of the second PSFCH with the conflict information,
the one or more processors is configured to process the instructions to control the first UE to:
transmit a sequence related to NACK.

41. The first UE according to claim 37, wherein
a first physical resource block (PRB) for the first PSFCH with the HARQ-ACK information is configured by a first radio resource control (RRC) parameter, and
a second PRB for the second PSFCH with the conflict information is configured by a second radio resource control (RRC) parameter, and
the first PRB for the first PSFCH with the HARQ-ACK information and the second PRB for the second PSFCH with the conflict information are different.

42. The first UE according to claim 32,
the one or more processors is configured to process the instructions to control the first UE to:
transmit, to a second UE, a first information related to inter-UE coordination scheme 2, and
transmit, to a network, the first information related to inter-UE coordination scheme 2.

43. A method performed by a first user equipment (UE), the method comprising:
based on a comparison between a first threshold value and a total number of first physical sidelink feedback channel (PSFCH) with Hybrid Automatic Repeat Request-ACKnowledgement (HARQ-ACK) information and second PSFCH with conflict information, and a comparison between a second threshold value and a total power of the first PSFCH with the HARQ-ACK information and the second PSFCH with the conflict information:
determining whether to use a first priority related to the first PSFCH with the HARQ-ACK information and a second priority related to the second PSFCH with the conflict information for determining a number of simultaneous PSFCH transmissions of the first PSFCH with the HARQ-ACK information and the second PSFCH with the conflict information.

44. The method according to claim 43, wherein
based on a determination that the total number of the first PSFCH with the HARQ-ACK information and the second PSFCH with the conflict information is smaller than or equal to the first threshold, and a determination that the total power of the first PSFCH with the HARQ-ACK information and the second PSFCH with the conflict information is smaller than or equal to the second threshold:
the method comprises determining the number of simultaneous PSFCH transmissions of the first PSFCH with the HARQ-ACK information and the second PSFCH with the conflict information.

45. The method according to claim 43, wherein
based on a determination that the total number of the first PSFCH with the HARQ-ACK information and the second PSFCH with the conflict information is smaller than or equal to the first threshold, and a determination that the total power of the first PSFCH with the HARQ-ACK information and the second PSFCH with the conflict information is greater than the second threshold, or
based on a determination that the total number of the first PSFCH with the HARQ-ACK information and the second PSFCH with the conflict information is greater than the first threshold, and a determination that the total power of the first PSFCH with the HARQ-ACK information and the second PSFCH with the conflict information is smaller than or equal to the second threshold, or
based on a determination that the total number of the first PSFCH with the HARQ-ACK information and the second PSFCH with the conflict information is greater than the first threshold, and a determination that the total power of the first PSFCH with the HARQ-ACK information and the second PSFCH with the conflict information is greater than the second threshold:
the method comprises determining, based on an ascending order of the first priority related to the first PSFCH with the HARQ-ACK information and an ascending order of the second priority related to the second PSFCH with the conflict information, the number of simultaneous PSFCH transmissions of the first PSFCH with the HARQ-ACK information and the second PSFCH with the conflict information.

46. The method according to claim 43, wherein
based on simultaneous transmission and reception of the first PSFCH with the HARQ-ACK information and the second PSFCH with the conflict information in a PUSCH transmission occasion:
the first priority related to the first PSFCH with the HARQ-ACK information is always higher than the second priority related to the second PSFCH with the conflict information.

47. The method according to claim 43, wherein
the second priority, related to the second PSFCH with the conflict information, corresponds to a priority value determined by a corresponding Sidelink Control Information (SCI).

48. The method according to claim 43, wherein
the method comprises:
communicating with a second UE via sidelink channel, and
determining, based on an identity of the second UE and a number of at least one first PSFCH resource available for multiplexing the conflict information in the second PSFCH, an index of one of the at least one first PSFCH resource for the second PSFCH with the conflict information.

49. The method according to claim 48, wherein
the index of one of the at least one first PSFCH resource for the second PSFCH with the conflict information is represented by a formula:
$$R = B\_ID mod R\_CI ,$$
wherein
R denotes the index of one of the at least one first PSFCH resource for the second PSFCH with the conflict information,
B_ID denotes the identity of the second UE, and
R_CI denotes the number of the at least one first PSFCH resource available for multiplexing the conflict information in the second PSFCH.

50. The method according to claim 48, wherein
the method comprises transmitting the second PSFCH with the conflict information in a first slot, wherein
the first slot includes the at least one first PSFCH resource, and
the first slot is at least one slots of a resource pool before a resource associated with the conflict information.

51. The method according to claim 48, wherein
for a case of the second PSFCH with the conflict information,
the method comprises transmitting a sequence related to NACK.

52. The method according to claim 48, wherein
a first physical resource block (PRB) for the first PSFCH with the HARQ-ACK information is configured by a first radio resource control (RRC) parameter, and
a second PRB for the second PSFCH with the conflict information is configured by a second radio resource control (RRC) parameter, and
the first PRB for the first PSFCH with the HARQ-ACK information and the second PRB for the second PSFCH with the conflict information are different.

53. The method according to claim 43,
the method comprises:
transmitting, to a second UE, a first information related to inter-UE coordination scheme 2, and
transmit, to a network, the first information related to inter-UE coordination scheme 2.
